(19) United States
(12) Patent Application Publication
(10) Pub. No.: US 2008/0227541 A1
(43) Pub. Date: Sep. 18, 2008

(54) Gaming method and apparatus for facilitating a game involving an expanding array

(76) Inventors: Bradley Berman, Minnetonka, MN (US); Ryan Strand, Hopkins, MN (US); Chad Shapiro, Plymouth, MN (US); Adam Martin, St. Louis Park, MN (US)

Correspondence Address: Hollingsworth & Funk, LLC, Suite 125, 8009 34th Avenue South, Minneapolis, MN, 55425, US

(21) Appl. No.: 12/004,451

(22) Filed: Dec. 20, 2007

Related U.S. Application Data
(60) Provisional application No. 60/877,756, filed on Dec. 29, 2006.

(51) Int. Cl. A63F 13/00

(52) U.S. Cl. 463/31

(57) ABSTRACT

A method and apparatus for use in gaming activities such as slot machine is provided. At least some elements of a grid are marked in an initial round. An additional round can be initiated if in the initial round a series of corresponding adjacent elements was created. In each additional round, marked elements may be added to the grid of the previous round. Each additional round can be initiated if the previous round increased the number of corresponding adjacent elements as compared with the previous round. A game can be ended when a round fails to expand the series of corresponding adjacent elements. A payout can be issued, wherein the amount of the payout is related to the number of corresponding adjacent elements of the series.

### RELATED APPLICATIONS

This application claims the benefit of Provisional Application No. 60/877,756, filed on Dec. 29, 2006, to which priority is claimed pursuant to 35 U.S.C. §119(e), and which is hereby incorporated herein by reference in its entirety.

### FIELD OF THE INVENTION

This invention relates in general to gaming systems and processes, and more particularly to a gaming method and apparatus for facilitating a game involving an expanding array.

### BACKGROUND OF THE INVENTION

Gaming devices such as slot machines have entertained the public for over a century. While the fundamental concept behind slot games has remained relatively intact, the manners of computing, displaying, and participating in modern day slot games have changed dramatically. One force driving these changes is technological advancement, such as the advent of computers and video capabilities. Another driving force is human nature, as the participants of such gaming devices demand continual excitement and stimulation. It is therefore important in the gaming industry that gaming innovations continue to be rolled out to the participating public.

Conventional slot games and the like involve relatively linear game play that can become repetitive and monotonous for a player. For example, a conventional slot machine involves repeatedly spinning three reels in an attempt to line reel symbols up in a configuration that triggers a payout. While the outcome of each game is not predictable, the manner of game play is identical each time the game is played. Such games can have limited ability in sustaining a player's interest as the game play becomes monotonous over time.

### SUMMARY

To overcome limitations in the prior art described above, and to overcome other limitations that will become apparent upon reading and understanding the present specification, the present invention discloses an apparatus and method for providing a game with an expanding array.

A method and apparatus for use in gaming activities such as slot machine is provided. At least some elements of a grid are marked in an initial round. An additional round can be initiated if in the initial round a series of corresponding adjacent elements was created. In each additional round, marked elements may be added to the grid of the previous round. Each additional round can be initiated if the previous round increased the number of corresponding adjacent elements as compared with the previous round. A game can be ended when a round fails to expand the series of corresponding adjacent elements. A payout can be issued, wherein the amount of the payout is related to the number of corresponding adjacent elements of the series.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIGS. 1A-1E illustrates one embodiment of a gaming activity utilizing an expanding array that includes an increasing number of corresponding elements in accordance with the invention;

FIG. 2 is a flow diagram of an exemplary embodiment of a method for utilizing an expanding array that includes an increasing number of corresponding elements in accordance with the invention;

FIGS. 3A-3F illustrates one embodiment of a gaming activity utilizing an expanding array that includes an increasing number of corresponding elements in accordance with the invention;

FIG. 4 is a flow diagram of an exemplary embodiment of a method for utilizing an expanding array that includes an increasing series of corresponding adjacent elements in accordance with the invention;

FIG. 5 is another flow diagram of an exemplary embodiment of a method for utilizing an expanding array that includes an increasing number of corresponding adjacent located elements in accordance with the invention;

FIG. 6 is an embodiment of a casino-style gaming device in which the principles of the present invention may be applied; and

FIG. 7 illustrates a representative computing system capable of carrying out operations in accordance with the invention.

### DETAILED DESCRIPTION OF THE ILLUSTRATED EMBODIMENTS

In the following description of the invention, reference is made to the accompanying drawings which form a part hereof, and in which is shown by way of illustration the specific embodiment in which the invention may be practiced. It is to be understood that other embodiments may be utilized, as structural and operational changes may be made without departing from the scope of the present invention.

Generally, the present invention is directed to a method and apparatus for providing an expanding array. The present invention provides games whereby a player can build upon previous successes, such that a game may not have a prescribed and predictable manner of game play and conclusion.

As will be discussed further, the invention provides for marking elements of a play area in an initial round. Additional rounds can be initiated if the previous round, such as the initial round, formed and/or expanded a series of corresponding adjacent elements. The series of corresponding adjacent elements can be expanded each round because new marked elements are added each round. A game can be ended when a round fails to expand the series of corresponding adjacent elements. A payout can be issued during, or at the conclusion of, the game, the amount of the payout being related to the number of corresponding adjacent elements of the series.

As one having ordinary skill in the art would understand, the greater the number of rounds progressed through, the greater number of elements added to the array, and consequently the greater chance of having larger series of corresponding adjacent elements with larger payouts.

The ability to advance to an indeterminate number of rounds adds several exciting elements to game play, which increases the overall enjoyment of the game. For example, player anticipation and excitement would build as a particular game progresses through the rounds, the player not knowing how many rounds will be reached. Also, a player could be given the impression that “the sky is the limit” with respect to game play and its associated payout. In some embodiments of the invention, a jackpot amount would not be displayed, but the game would nevertheless be capable of reaching equally high payouts because of the unlimited number of rounds that could be played in a single game, as long as the addition of marked elements in each round continues to expand the series of corresponding adjacent elements. Moreover, some players find enjoyment by building off of prior winnings and/or the perception of momentum in a game, of which both aspects can be provided in various embodiments of the invention.

As is described more fully below, the present invention provides an expanding array that includes an increasing number of correspondingly marked elements. However, the invention is equally applicable in connection with secondary modes, such as bonus modes of play. As is known in the art, bonus events are used in gaming activities such as slot games, which provides an alternative mode of play that is intended to attract and captivate players of such slot games. Generally, a bonus game or event on a slot machine is typically an additional gaming reel or machine, or a random selection device, that is enabled by a bonus qualifying signal from an underlying or primary gaming activity. Generally, a predetermined prize-winning combination of symbols in an underlying or primary slot game may result in the player being awarded one or more bonus games. Often the bonus event has a much higher probability of winning, thereby instilling a great interest by players in being awarded bonus events. There are various secondary or “bonus” events known in the art. Thus, while an exemplary embodiment of the present invention is described in connection with a standard or primary mode of play, the present invention is equally applicable in secondary or bonus modes of play.

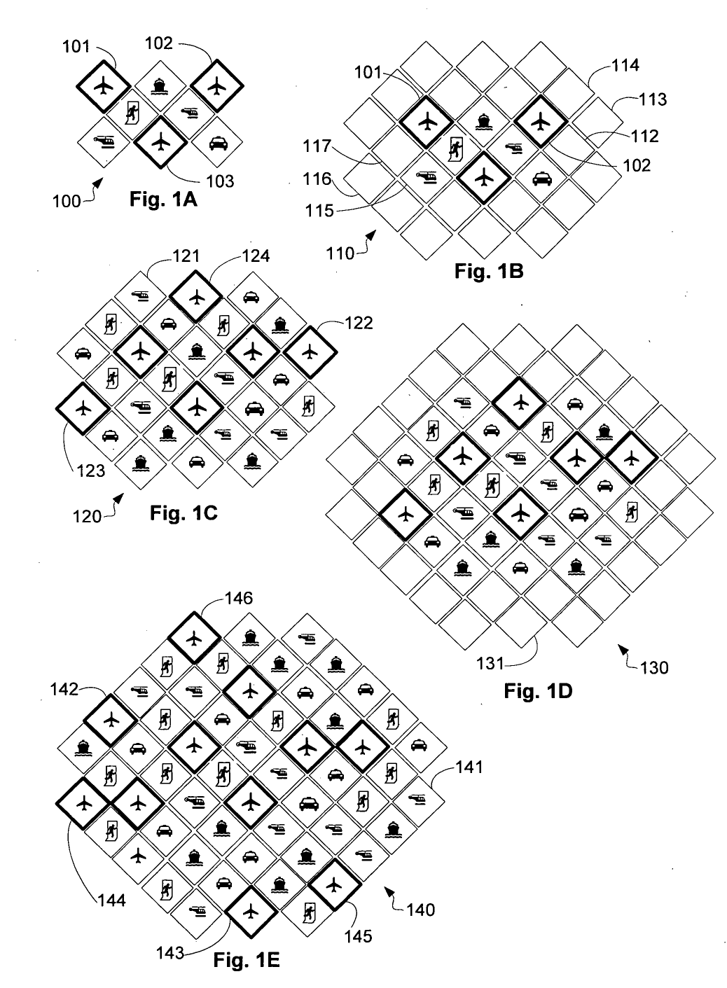

FIGS. 1A-1E illustrates a gaming activity utilizing an expanding array that includes an increasing number of corresponding elements. Element array 100 of FIG. 1A includes eight elements, such as elements 101, 102 and 103. All elements of element array 100 are squares. However, according to various embodiments of the invention, elements of arrays could take the form of, but are not limited to, circles, ovals, triangles, pentagons, hexagons, octagons, and the like.

All of the elements of element array 100 have been marked. For example, elements 101, 102 and 103 have been marked by a symbol resembling a plane. Marking includes distinguishing at least one element from at least one other element. There are many ways in which one element can be distinguished from another element, and therefore there are many different ways to mark an element. For example, an element could be marked-simply by it being created or located in an array or display area. Marking can also include placing and/or representing a symbol, one or more colors, flag, characters, images, graphics, numbers, letters, shapes, features, or designs on, or associated with, an element.

One element can be distinguished from another element by locating the elements at different heights, rotating one or both of the elements, flipping one or both of the elements, moving one or both of the elements, resizing one of both of the elements, deforming one or both of the elements, modifying one or both of the elements and/or combining one or both of the elements with at least one other element. Distinguishing of elements can be done to physical elements, such as element pieces of a board or on a reel strip. Distinguishing of elements can also be done to elements represented on a display screen.

In some embodiments of the invention, elements are not marked by any symbol, color, letter or numeral, and in those embodiments, the elements themselves can be markings.

Elements 101, 102 and 103 are highlighted, shown in this embodiment by having a thicker border, because the elements each are marked with a plane symbol and therefore correspond to one another. In the particular embodiment illustrated in FIGS. 1A-F, correspondence between elements requires not only an identical symbol, but also that at least three identically marked elements are displayed in the first round of game play. As such, even though two helicopter symbols are shown, they do not correspond according to the illustrated embodiment, because the threshold number of identical elements for correspondence is three for the first round of game play. However, the invention is not so limited, and in other embodiments, any other number could be required for the elements to correspond in the first round, including two identically marked symbols.

FIG. 1B illustrates the start of a second round, the first round being illustrated in FIG. 1A. Because three corresponding elements were displayed in the element array 100 of the first round, a second round is initiated.

In the second round, element array 110 is created by adding elements to the perimeter of element array 100. For example, elements 112, 113 and 114 are added in positions such that elements that were on the perimeter of element array 100 in the first round are not on the perimeter of element array 110 of the second round once the additional elements are added. Therefore, element 102, which was on the edge of element array 100 before the expansion in the second round, is not on the edge of element array 110. Instead, element 102 is surrounded by added edge elements, such as elements 112, 113 and 114.

Element 115, which was on the edge of element array 100 in the first round, is not on the edge of element array 110 of the second round because added elements, such as added elements 116 and 117, among others, surround element 115 such that no edge of element 115 is not adjacent to the edge of another element and no corner of element 115 is not adjacent to three other corners of three other elements of the element array 110. However, various other ways for determining whether an element is located on the edge of an element array should be apparent to one having ordinary skill in the art upon reading this disclosure, and such various ways are contemplated within the scope of this disclosure.

In some embodiments of the present invention, only elements which would be adjacent to corresponding elements are added in each additional round. For example, in such an embodiment, element 117 is adjacent to corresponding element 101, and as such, element 117 is added to the element array 110 in the second round. However, element 116 is not adjacent to a corresponding element, such as corresponding element 101, and therefore element 116 would not be added in the second round of an embodiment that requires that added elements only be added in locations that are adjacent to corresponding elements.

According to various embodiments of the invention, there are several different ways in which an element could be considered to be on the edge of an array, and not every way will be operative for all embodiments. For example, in some embodiments, element 112 could be considered to be on the edge of the element array 110 because element 112 includes a corner that is not surrounded on all sides (i.e. it has a corner that is adjacent to only two other corners, while three adjacent corners would be required to insulate element 112 from the edge of element array 110). However, in some embodiments of the invention, element 112 would not be considered to be on the edge of element array 110. In such embodiments, a reason that element 112 is not considered to be on the edge of element array 110 is because element 112 does not have an edge that is not adjacent to another edge of an element of the element array 110.

FIG. 1C illustrates the result of the second round. Elements of element array 110 that were added to element array 100 have been marked, each with a symbol. Some of the elements added in round two have been marked with plane symbols, such as elements 122, 123 and 124. These marked elements have also been highlighted to further signify that they correspond to the elements previously marked with plane symbols, which are also highlighted.

In some embodiments of the invention, only those particular marking types that corresponded in the first round will continue to correspond in later rounds. Element 121 has been marked in round two with a helicopter symbol, but since such a symbol does not correspond to the corresponding marking determined in round one, element 121 does not correspond to other elements in this particular embodiment, including other elements marked with the helicopter symbol. However the invention is not so limited and in some embodiments correspondences between elements and markings can be established in later rounds, regardless of what transpired in an earlier round.

The element array 120 of FIG. 1C includes six corresponding elements, each highlighted and marked with a plane symbol. Among the various embodiments of the present invention, several different rule systems may determine whether the outcome of round two allows another round to be initiated. For example, some embodiments of the present invention require that the total number of corresponding elements be increased in each round in order for the next round to be initiated. Various other embodiments of the present invention require that the addition of marked elements in a particular round must increase the total number of corresponding marked elements in the array by a predetermined amount, such at two or three, but other amounts are also contemplated. In such embodiments, the predetermined amount may be constant for each round, or the amount my change each round. For example, as one having ordinary skill in the art will understand, later rounds of some embodiments may add more marked elements in each later round than earlier rounds, because the array is larger and a larger perimeter and/or number of corresponding elements must be supplemented with additional marked elements in each round. In such embodiments, the number of corresponding marked elements needed to be added in each round in order to advance the game to the next round may increase as the game progresses through the rounds.

The particular embodiment illustrated in FIG. 1C requires that the number of correspondingly marked elements be at least three to advance between round one and round two, and that the addition of marked elements in round two at least double the number of correspondingly marked elements in order to advance from round two to round three. Therefore, because the corresponding marked elements 122, 123 and 124 were added in round two, a third round is initiated.

FIG. 1D illustrates the start of the third round. In the third round, elements are added to the element array 130, such as element 131, in a fashion similar to that of round two. In round three, elements are added to the perimeter of element array 120 such that no element that was on the edge of element array 120 in round two is on the edge of element array 130 in round three.

FIG. 1E illustrates the result of the third round. Elements of element array 130 that were added to element array 120 have been marked, each with a symbol, as shown in element array 140. Some of the elements added in round three have been marked with plane symbols, such as elements 142, 143, 144, 145 and 146. These marked elements have also been highlighted to further signify that they correspond to the elements previously marked with plane symbols, which are also highlighted.

Although five plane symbols were added in round three, this number of added corresponding symbols does not double the number of corresponding symbols present in the previous round. As such, the embodiment illustrated in FIG. 1E does not initiate a fourth round. However, the present invention is not so limited and various other rules of the various embodiments of the invention applied to the result of round three, illustrated in FIG. 1E, could allow a forth round to be initiated.

As discussed further below, a payout may be issued based on the outcome illustrated in FIG. 1E. The amount of the payout may be related to the total number of corresponding elements of the element array 140. Additionally, other characteristics of the element array 140 may be used to determine, or add to, a payout, such as, but not limited to, the correspondence of other symbols, the presences of special markings (such as bonus symbols or multipliers), and patterns formed by the elements and/or markings.

During the course of the various rounds, the symbol marking for each element of the may be randomly selected from a plurality of different possible markings for each element, random selection means being known in the art and further discussed herein. Alternatively, each symbol marking may be selected and placed according to a pre-made plan, and thereby not done randomly.

In some embodiments of the invention, a particular type of marking can be repeatedly used to mark elements. In other embodiments, a particular type of marking can only be used to mark elements a certain number of times in a particular game or round.

While elements 101, 102 and 103 of correspond to one another by each having an identical plane marking, there are various other ways in which elements can correspond to one another, according to various embodiments of the invention. For example, elements could correspond to one another not by having the same mark, but rather by just having a mark. But in some embodiments of the invention, elements will only correspond if they have the same letter, number, symbol, image, color, or other similar marking. In some embodiments of the invention, elements will correspond if they are marked with markings selected from a particular group, and the elements need not all have identical markings to correspond to one another. For example, elements may correspond to one another because each is marked with an image of a dog, even though all image markings on the elements are of a different breed of dog.

In some embodiments of the invention, elements correspond to one another if their markings form a progressive series. In such embodiments, adjacent elements might only correspond if they are marked with consecutive numbering. In other embodiments, letter marked elements may only correspond if the adjacent elements spell a word. In some embodiments, marked elements may correspond if a word can be spelled from the marked elements of an array, regardless of whether the elements are adjacent to one another. However, the present invention is not so limited. Other types of element correspondence are contemplated and should be realized by one having ordinary skill in the art upon reading this disclosure.

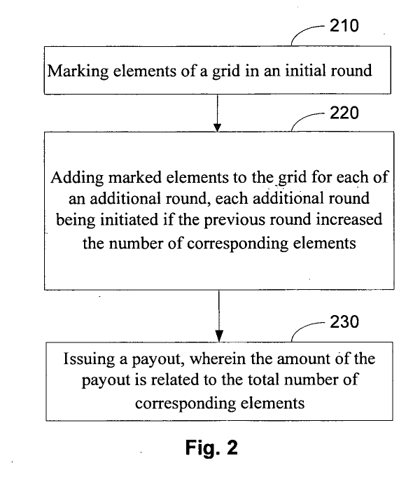

FIG. 2 is a flow diagram of an exemplary embodiment of a method for utilizing an expanding array that includes an increasing number of corresponding elements in accordance with the invention.

A grid is marked 210 in an initial round. Marked elements are added 220 to the grid for each of an additional round. According to the adding 220 step, each additional round is initiated if the previous round increased the number of correspondingly marked elements as compared to the previous round. “The previous round” of the adding 200 step could be any round, including the first (initial) round, second round, third round, and so on. If “the previous round” is the initial round, then the second round is initiated if the initial round increased the number of correspondingly marked elements as compared to the previous round. While there is no round “previous” to an initial round that is actually played out, according to the embodiment discussed in illustrated in FIG. 2, if the initial round increases (from zero) the number of correspondingly marked elements, than a second round is initiated.

As discussed above, dependent upon the rules for each embodiment, two elements can each be marked by identical symbols, but because the rules of the particular embodiment require that a certain number of identically marked elements be present, such as three, the mere two elements marked by identical symbols can nevertheless fail to correspond. In such an occurrence, a second round would not be initiated.

The flow diagram of FIG. 2 further includes issuing 230 a payout. According to the embodiment of FIG. 2, the amount of the payout is related to the total number of corresponding marking elements. The adding 220 step could be repeated for any number of additional rounds, as long as the criteria for initiating an additional round, discussed in block 220, are satisfied. When the outcome of a particular round fails to satisfy the criteria of block 220, then the embodiment processes to the payout issuing 230 step.

According to the flow diagram of FIG. 2, the payout issued 230 is related to the total number of corresponding marking elements. Many different types of relatedness are contemplated within the scope of this disclosure. For example, the amount of the payout could be directly related to the total number of corresponding elements.

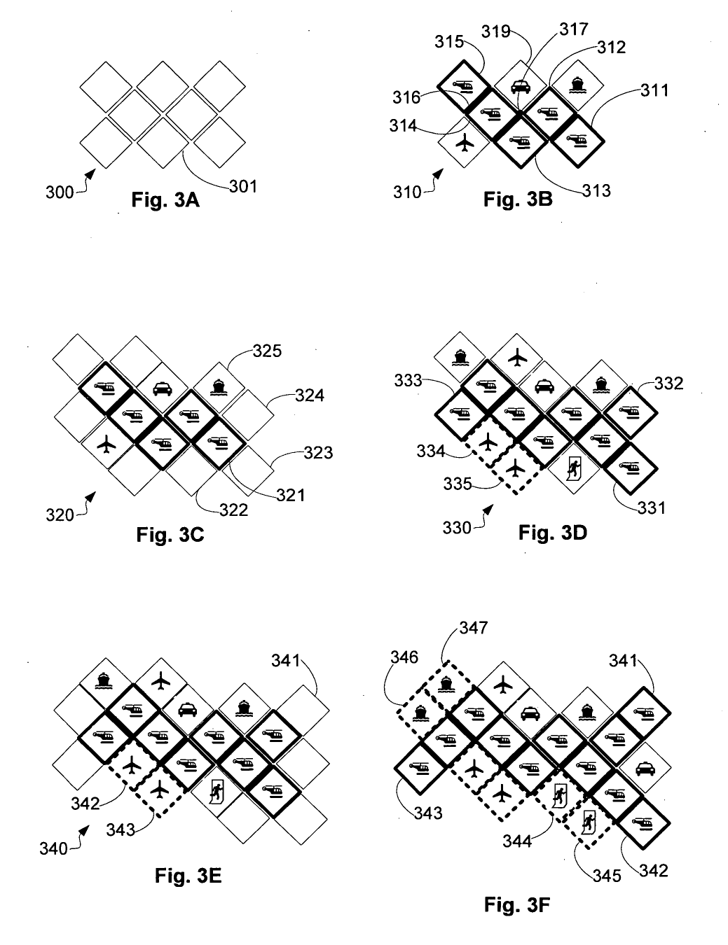

FIGS. 3A-3F illustrates one embodiment of a gaming activity utilizing an expanding array that includes an increasing number of corresponding elements in accordance with the invention. FIG. 3A illustrates the beginning of a first round of a game. Presented in the first round of the game is element array 300, which includes element 301. The element array includes eight elements, but according to various embodiments of the present invention, the first round of a game can include any number of elements, including one.

FIG. 3B illustrates the progression of the first round of a game. FIG. 3B illustrates that the element array 300 has been marked with symbols to create marked element array 310. The marked element array 310 includes five corresponding elements, 311, 312, 313, 314 and 315, each marked with a helicopter symbol. The elements 311, 312, 313, 314 and 315 correspond because each is marked with an identical symbol.

Although elements of the embodiment illustrated in FIGS. 3A-F first appear as unmarked elements and then are marked, the elements could first appear as marked elements, or could first appear as having a different or generic marking before being marked with a final marking.

Elements 311, 312, 313, 314 and 315 not only correspond to one another, but also form a series of adjacently located elements. There are many different ways in which an element of the various embodiments of the invention can be adjacent to another element. For example, two elements could be considered to be adjacent to one another if they share a common corner, such as the corner 317 shared by marked elements 312 and 314. However, various embodiments of the present invention do not consider the mere sharing of a corner to make two elements adjacent, as is the case in the embodiment illustrated in FIGS. 3A-F.

Another type of adjacency, which is embodied in FIGS. 3A-F, requires that two elements share a common wall. For example, marked elements 314 and 315 are adjacent because they share a common wall 316. Two elements may share a common wall despite there being a small gap illustrated between the framing of each element. Two square elements may be adjacent in various embodiments because their respective proximate and opposing walls are aligned against one another. Adjacency in this sense, for this particular embodiment, relates to the concept of how the elements of the element array 310 are orientated with respect to each other and not precisely how each element, and each element frame, is illustrated.

One element can be adjacent to multiple other elements. For example, marked element 312 is adjacent to both marked elements 313 and 311. Furthermore, marked element 312 could be adjacent to both marked elements 311 (both sharing a common wall) and 314 (both sharing a common corner), although such corner adjacency is not operative for the particular embodiment illustrated in FIGS. 3A-F.

According to various embodiments of the invention, elements in contact with and/or within close proximity to one another can be considered to be adjacent. Elements can be in contact with one another by sharing walls, lines, points, segments, portions and/or features. Elements can also be in contact by overlapping each other. Other types of adjacency may be provided as well. For example, in one embodiment, only those symbols that are adjacent in a horizontal, vertical, or diagonal fashion will be deemed “adjacent” for purposes of providing a payout. Alternatively, only symbols that are horizontal, or that are vertical, or that are diagonal, may be deemed adjacent. Symbols may also be deemed adjacent along opposite edges of the play area, as if the edges were wrapped around to intersect with one another. Three dimensional display grids may also be used in accordance with the invention, such that elements sharing a wall, corner or segment may be considered to be adjacent.

The rules of the particular embodiment illustrated in FIGS. 3A-F require the formation of a series of five corresponding adjacent elements in the first round in order for the game to initiate a second round. Such a series of five corresponding adjacent elements was created in the first round, shown as highlighted elements 311, 312, 313, 314, and 315, each marked with a helicopter. Therefore, a second round will be initiated. Had a series of five corresponding adjacent elements not been formed in the first round, then the game would end after the first round. Moreover, if no series of five corresponding adjacent elements was created, then a payout would not be issued.

FIG. 3C illustrates the start of the second round. Elements have been added to the element array 310 of the first round. According to the rules of the particular embodiment illustrated in FIGS. 3A-F, elements are only added in each round in locations that are adjacent to one of the marked elements of the series of corresponding adjacent elements. For example, highlighted element 321 is part of the series of five corresponding adjacent elements, and elements 322, 323, and 324 have been added to the remaining adjacent locations of highlighted element 321.

In various embodiments of the invention where elements are only added in each round to locations that are adjacent to one of the elements of the series of corresponding adjacent elements, then placement of each added element will depend upon how that particular game embodiment defines adjacency. For example, if the embodiment illustrated in FIG. 3C used corner adjacency in addition to side adjacency, then five elements would have been added adjacent to highlighted element 321, which would have included two added elements adjacent to highlighted element 321 at the corners of highlighted element 321.

Element 325 does not correspond to the other elements of element array 320. Therefore, according to the rules of the particular embodiment illustrated in FIGS. 3A-F, element 325 does not cause an element to be added adjacent to itself. However, element 325 can nevertheless have an element added to a location adjacent to element 325. For example, element 324 is added to the element array 310, and is located adjacent to element 325. It is highlighted element 321 that caused element 324 to be added at its particular location, and not anything having to do with element 325.

FIG. 3D illustrates the progression of the second round. Elements added to the element array 310 in the second round have each been marked with a symbol. For example, element 335 has been marked with a plane symbol and element 332 has been marked with a helicopter symbol.

Highlighted elements 331, 332 and 333 have all been marked with helicopter symbols, and because this particular embodiment only adds elements to spaces adjacent to the series of corresponding adjacent elements, highlighted elements 331, 332 and 333 become part of the series. One having ordinary skill in the art would also recognize that three separate series can now be identified, one series between highlighted elements 331 and 333 (comprised of seven elements), another series between highlighted elements 332 and 333 (comprised of seven elements) and a series between elements 331 and 332 (comprised of three elements). Various embodiments of the present disclosure, including the embodiment illustrated in FIGS. 3A-F, consider multiple series to all be part of the same series, and do not distinguish between the series until the game has concluded.

Elements 334 and 335 have been highlighted by dashed borders. Elements 334 and 335 were highlighted because their markings correspond to each other and they are adjacent. These elements are not part of the series of corresponding adjacent elements that was formed in the first round. In some embodiments of the invention, a payout will be issued for adjacent corresponding elements 335 and 335 before the next round is commenced. However, in other embodiments of the invention, a payout will be issued only at the conclusion of the game. Issuing payouts only at the conclusion of the game can increase the pace of the game, heighten player anticipation, and allow series, combinations, bonus, and payouts accumulate through the rounds. Likewise, payouts can be issued at each round for the formation and expansion of a series of corresponding adjacent elements, and/or a payout can be made at the conclusion of the game.

According to the rules of the particular embodiment illustrated in FIGS. 3A-F, a third round is initiated because the series of corresponding adjacent elements was expanded in the second round. In various embodiments of the invention, advancement between rounds will require not only expansion of a series, but expansion by a predetermined number of elements. However, the embodiment illustrated in FIGS. 3A-F is not so limited and the expansion of the series by the corresponding elements in the second round is sufficient to initiate a third round.

FIG. 3E illustrates the start of the third round. In the third round, elements are added to the element array 330 of round two. As in round two, elements added in round three are only added to locations that are adjacent to at least one of the elements of the series of corresponding adjacent elements. Element 341 is an example of an element added in round three.

No elements added in round three were added adjacent to elements 342 or 343. This is because, according to the rules of the particular embodiment illustrated in FIGS. 3A-F, elements are only added in each round to locations adjacent to the series of corresponding adjacent elements. However, in some embodiments of the invention, elements can be added adjacent to elements 342 and 343 because elements 342 and 343 correspond.

FIG. 3F illustrates the progression of the third round and the end result of the game. Elements added to the element array 330 in the third round have each been marked with a symbol. For example, element 346 has been marked with a boat symbol and element 345 has been marked with a running symbol. The marking of the elements added in round three has further expanded the series of corresponding adjacent elements by marking each of elements, 341, 342 and 343, with a helicopter symbol.

The series of corresponding adjacent elements includes three identifiable segments, one segment between elements 341 and 342 (comprised of five elements), another segment between elements 341 and 343 (comprised of nine elements) and a segment between elements 342 and 343 (comprised of nine elements).

According to the rules of the particular embodiment illustrated in FIGS. 3A-F, the game includes up to, but not more than, three rounds.

At the conclusion of the game illustrated in FIGS. 3A-F, a payout can be issued. According to the various embodiments of the invention, payouts can be issued for a variety of different occurrences. Payouts can be based on the number of rounds the game proceeded through. Payouts can also be based on the number and type of element markings present at the end of the game. For example, a payout can be made for the series of corresponding adjacent elements, the payout related to the total number of elements in the series. Payouts can also be made for the appearance of certain element markings, such as bonus symbols. Payouts can also be made for correspondingly marked adjacent elements that are not part of the series, such as marked elements 344 and 345 (both marked with running symbols) and elements 346 and 347 (both marked with boat symbols).

Payouts can also be made for the total number of elements comprising the series of corresponding adjacent elements. Payouts can also be made for each of the segments of the series of corresponding adjacent elements. Since the series of corresponding adjacent elements is made up of three identifiable segments, as discussed above, a payout could be calculated and paid for each of the segments, the amount of the payout related to the number of elements in each of the segments.

Although one particular set of rules was discussed above in connection with the embodiment illustrated in FIGS. 3A-F, a different set of rules could be applied and yet the game outcome could be the same. For example, in some embodiments of the invention, initiation of a second round and other subsequent rounds may require not only the formation of a series of corresponding adjacent elements, but also that the series extend to an edge of the element array, or two edges of the element array. Various embodiments may require that at least two elements of the series extend to an edge of the element array in order for the next round to be initiated.

For example, in FIG. 3B, element 315 of the series of corresponding adjacent elements is located on the edge of element array 310, as is element 311. The particular rules for corner adjacency may be important for identifying which elements are located on an edge of an array. For example, in embodiments where corner adjacency can be used to form the series of corresponding adjacent elements, element 314 of FIG. 3B may be considered to be on the edge of element array 310, but without corner adjacency, element 314 would not be on the edge of element array 310.

In various embodiments of the invention, a player is given a choice on whether to proceed onto the next round. In such embodiments, the player is given a choice on whether to issue a payout for all winnings accumulated during the course of the game, or whether to continue and risk losing some or all of the winnings accumulated during the course of the game. In such embodiments, if a round is initiated, but during the course of that round the conditions are not met for another round, then some or all of the accumulated winnings can be lost. For example, in FIG. 3B, the end result of the first round means that a second round can be initiated, but in this particular embodiment the player is given a choice whether to initiate the second round or take the payout for the already created series of corresponding adjacent elements. If the second round is initiated and the results of the round would not qualify for initiating a third round, then some or all of the payout that would have been issued for the series of corresponding adjacent elements is lost (from the player's perspective). Such choice given to the player increases player control, which can increase player interest. Also, the risk of initiating each round would heighten the anxiety and anticipation associated with game play, and would thereby increase the excitement level for the player.

In various embodiments of the invention, a series of corresponding adjacent elements can be dynamically identified. Dynamic identification includes locating winning segments that can take any number of forms. As opposed to classic three reel strip slot matching, where a series of winning symbols could only be formed along one row, dynamic identification allows segments to be formed in many other ways, including segments that repeatedly change direction along their length.

In various embodiments of the invention, a series of adjacent elements must be arranged in a particular orientation to correspond and trigger a payout. For example, elements 315, 314, 313, 312, and 311 of FIG. 3B are arranged left to right, and would therefore satisfy the criteria of an embodiment requiring that corresponding adjacent elements be arranged in a left to right manner. Other orientation criteria are also contemplated, such as top to bottom, and diagonally (a combination of left to right and top to bottom).

One having ordinary skill in the art will understand that certain orientations, such as left to right between two specific elements, can correspond to pre-defined pay lines. For example, a pay line can be defined between elements 315 and 311, for which a series of corresponding adjacent elements must be distributed through elements 315, 314, 313, 312, and 311. Another pay line could be define between elements 315 and 311, but require that a series of corresponding adjacent elements must be distributed through elements 315, 314, 317, 312, and 311. In this way, one having ordinary skill in the art will realize that a variety of different pay lines can be defined with the arrays disclosed herein.

Each of the various pay lines can correspond to a different payout. Also, a series of adjacent elements may not need to fill each element space of a pay line. For example, a pay line may be defined through elements 315, 314, 317, 312, and 311, wherein two series of corresponding adjacent elements can be identified, comprising elements 315 and 314, and elements 312 and 311, each series corresponding to a payout in various embodiments of the invention.

In various embodiments of the invention, pay lines may need to be enabled for a particular game. For example, a player may be required to place a unique bet for each particular pay line. In such a case, a player not enabling all pay lines may be given the opportunity to select which pay lines will be enabled, wherein only those pay lines that are enabled can be used to form a series of corresponding adjacent elements that triggers a payout. In various embodiments of the invention, marked elements will still appear along non-enabled pay lines, but a series of adjacent corresponding elements within those series will not trigger a payout and/or trigger additional rounds. In some embodiments of the invention, a series of adjacent corresponding elements in a non-enabled pay line may trigger an additional round, but not a payout. Alternatively, a series of adjacent corresponding elements in a non-enabled pay line may trigger a payout, but not an additional round. In some embodiments of the invention, a particular pay line may require two types of enablement, such as enablement for triggering a payout and enablement for triggering one or more additional rounds, each type of enablement requiring a unique bet.

In some embodiments of the invention, pay lines expand when the array expands. In some embodiments of the invention, pay lines do not expand as the array expands.

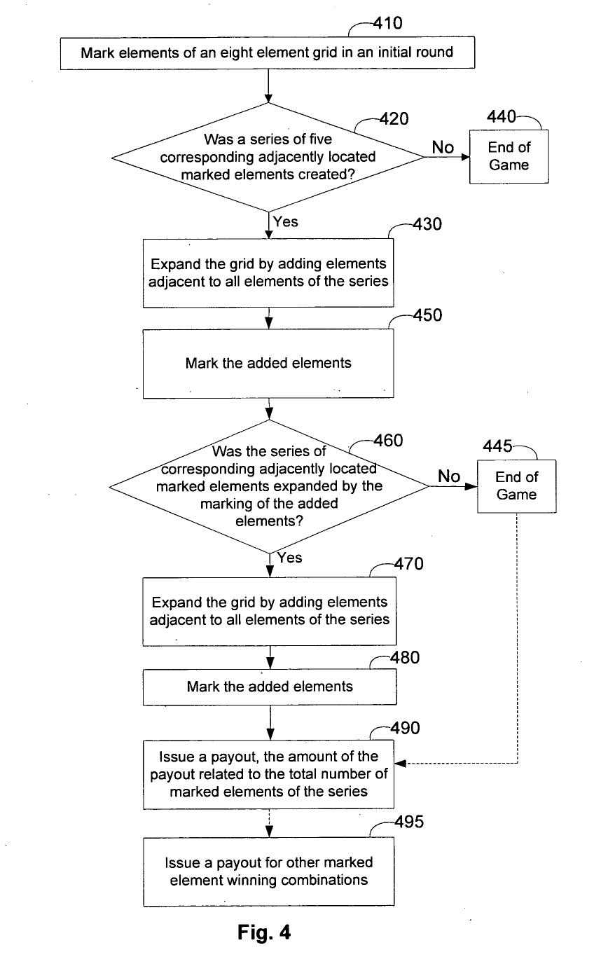

FIG. 4 is a flow diagram of an exemplary embodiment of a method for utilizing an expanding array that includes an increasing series of corresponding adjacent elements in accordance with the invention. Some embodiments of the invention that follow the flow diagram of FIG. 4 may also follow the embodiment illustrated in FIGS. 3A-F.

The flow diagram includes marking 410 elements of an eight element grid in an initial round. The flow diagram further includes identifying whether a series of five corresponding adjacent elements was created 420. The various adjacency rules discussed herein could be used in the embodiments of the invention that follow the flow diagram of FIG. 4.

If step 420 fails to identify a series of five corresponding adjacent elements in the eight-element grid, than the method moves onto step 440, which signifies the end of the game. However, if step 420 does identify a series of five corresponding adjacent elements in the eight element grid, then the grid is expanded 430 by adding elements adjacent to all elements of the series. Then the added elements are marked 450 in a way that can be similar to the way used in marking step 410. However, in various embodiments of the invention, marking can be done in different ways between the various steps and rounds of the game.

After the added elements are marked 450, the method identifies whether the series of corresponding adjacent elements was expanded by the marking of the added elements 460. In some embodiments of the invention, it might also be evaluated whether the series of corresponding adjacent elements was expanded such that at least one of the elements is located on the edge of the element grid, and this can further determine whether another round is initiated.

If the series of corresponding adjacent elements was not expanded by the marking of the added elements, then the game is ended 445, although in some embodiments, a payout may be issued 490, the amount of the payout related to the total number of marked elements of the series.

If the series of corresponding adjacent elements was expanded by the marking of the added elements, then the grid is further expanded 470 by adding elements adjacent to the elements of the series. In some embodiments of the invention, step 470 is conducted according to the same procedures as step 430, although in other embodiments the steps may not be done in the same way.

Once the grid is expanded 470 by the addition of elements, the added elements are marked 480. In some embodiments of the invention, the marking step 480 is conducted according to the same procedures as step 450 and/or step 410, although in other embodiments the steps are not done in the same way.

Once the elements added in the second expansion are marked 480, a payout is calculated and issued 490, the amount of the payout related to the total number of marked elements of the series. As one having ordinary skill in the art would understand, the greater the number of rounds progressed through the greater number of elements added to the array, and consequently the greater chance of having larger series of corresponding adjacent elements with larger payouts.

The flow diagram of FIG. 4 may optionally include issuing a payout 495 for other marked element winning combinations. Such other marked wining combinations may include the marking of elements with one or more bonus symbols, one or more multiplier symbols which increase other payouts, such as the payout of step 490, and/or corresponding adjacent elements. For example, elements 344 and 345 of FIG. 3F could warrant a payout in step 495 because the player received two corresponding adjacent elements.

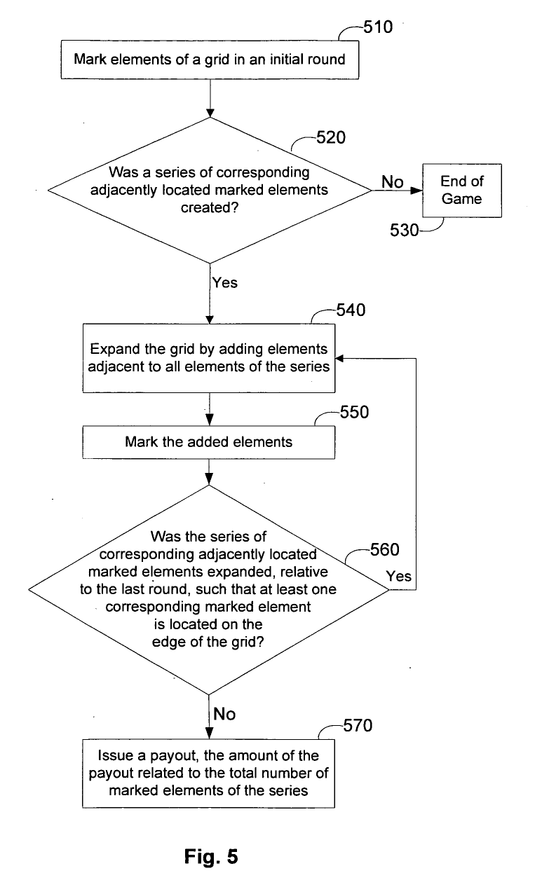

Although the flow diagram of FIG. 4 allows for a maximum of three rounds, the flow diagram of FIG. 5 allows for an unlimited number of rounds. In FIG. 5, generally, additional rounds are initiated as long as certain conditions are met.

The flow diagram of FIG. 5 includes marking 510 elements of a grid in an initial round. The grid could be any grid or array as herein described, and could be composed of any number of elements. The flow diagram of FIG. 5 further includes identifying whether a series of corresponding adjacent elements was created 520. Any of the various correspondence rules discussed herein may be used for the various embodiments of the inventions that follow the flow chart of FIG. 5. Any of the various adjacency rules discussed herein could be used for the various embodiments of the invention that follow the flow chart of FIG. 5.

Various embodiments of the invention may require different series lengths, such that in some embodiments two adjacent elements do not constitute a series of corresponding adjacent elements but three adjacent elements do form a series of corresponding adjacent elements. Other series minimums are also possible in various other embodiments of the invention. In various embodiments of the invention, step 520 may also identify whether a minimum number of elements of the series of corresponding adjacent elements are located on the edge of the grid, and require such identification as a prerequisite for advancing to the next round (step 540) and not terminating the game (step 530).

If step 520 fails to identify a series of corresponding adjacent elements in the grid, than the method moves onto step 530, which signifies the end of the game. However, if step 520 does identify a series of corresponding adjacent elements in the grid, then the grid is expanded 540 by adding elements adjacent to all elements of the series. In some embodiments of the invention, the added elements are added not only adjacent to all elements of the series, but also to all available spaces that are adjacent to marked elements of the grid. In such a way, the added elements may be added around the entire periphery of the grid. In some embodiments, the added elements are added in such a way that several peripheral layers are added in each round, such that some of added elements will only be adjacent to other added elements and will not be adjacent to any previously marked elements.

Once the elements are added for the particular round, the added elements are marked 550. After the added elements are marked 550, the method identifies whether the series of corresponding adjacent elements was expanded by the marking of the added elements 560.

If the series of corresponding adjacent elements was not expanded by the marking of the added elements, then the game is ended 570 and a payout is issued 570, the amount of the payout related to the total number of marked elements of the series.

If the series of corresponding adjacent elements was expanded by the marking of the added elements, then flow chart of FIG. 5 starts an additional round by going through the steps of expanding 540, marking 550 and evaluating 560. This loop can continue for any number of rounds until the conditions of step 560 are not satisfied, in which case the game would be ended and a payout issued 570.

In some embodiments of the invention, multiple series of corresponding adjacent elements can be created in the initial round, or in subsequent rounds. In such embodiments, elements may only be added to locations adjacent to the elements of the series of corresponding elements. But elements may also be added in any other way discussed herein. Also, the various rules discussed herein for element addition, element marking, round advancement and game termination may be employed to embodiments with multiple series of corresponding adjacent elements. For example, some embodiments of the invention may only require that one of the series be expanded in each round in order to advance to the next round, while other embodiments may require that all of the series be expanded. Likewise, some of the embodiments of the invention may add elements in each round adjacent to elements of the series only if that series was expanded in the prior round. As one having ordinary skill in the art would understand, many different combinations of the rules discussed herein for the various aspects of the game could be employed for embodiments that allow for the formation of multiple series of corresponding adjacent elements.

Various embodiments of the invention include marking elements such that the elements become wild elements or otherwise presenting one or more wild elements. Wild elements are capable of corresponding to any other elements, including a plurality of different markings simultaneously. An element could become a wild element because it was randomly marked as such, or the wild element could be located in the grid or array before other elements are located and/or marked.

As one having ordinary skill in the art will understand, the addition of wild elements increases the chances of forming series of corresponding adjacent elements. The use of wild elements can be used to control the odds of a player winning and/or to enhance the thrill of game play.

Various embodiments of the invention include marking elements such that the elements become null elements or otherwise presenting one or more null elements. Null elements are not capable of corresponding to other elements. An element could become a null element because it was randomly marked as such, or the null element could be located in the grid or array before other elements are located and/or marked.

As one having ordinary skill in the art will understand, the addition of null elements diminishes the chances of forming winning segments of corresponding adjacent elements. The use of null elements can be used to control the odds of a player winning and/or enhance the thrill of game play.

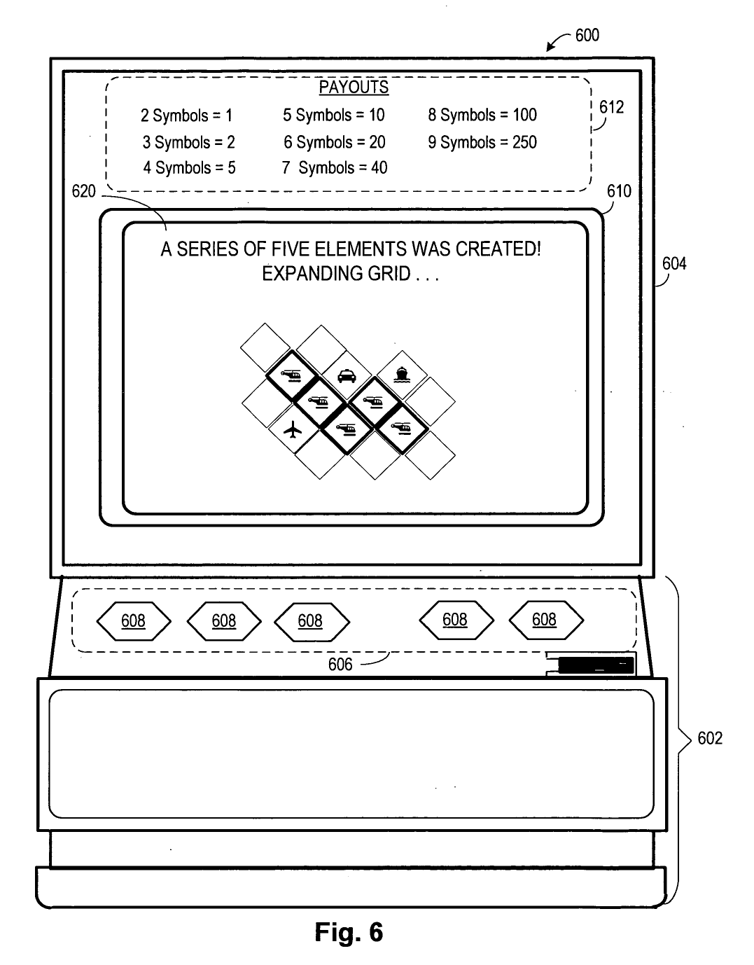

FIG. 6 is an embodiment of a casino-style gaming device in which the principles of the present invention may be applied. The slot machine 600 is a structure including at least a computing system, a housing, and a display. The housing includes a base 602 and a display device 604 to allow the slot machine 600 to be a self-supported, independent structure. The base 602 includes structure supporting the slot machine 600, and also includes a user interface 606 to allow the user to control and engage in play of the slot machine 600. The particular user interface mechanisms associated with user interface 606 is dependent on the type of gaming machine. For example, the user interface 606 may include one or more buttons, switches, joysticks, levers, pull-down handles, trackballs, voice-activated input, or any other user input system or mechanism that allows the user to participate in the particular gaming activity. The user input 606 allows the user to enter coins or otherwise obtain credits through vouchers, tokens, credit cards, etc. Various mechanisms for entering such vouchers, tokens, credit cards, coins, point tickets, etc. are known in the art. For example, coin/token input mechanisms, card readers, credit card readers, smart card readers, punch card readers, and other mechanisms may be used to enter wagers. The user input may include a plurality of buttons 608, which allow the user to initiate the game play in accordance with the invention, enter a number of credits to play, select options, cash out, automatically bet the maximum amount, etc. It should be recognized that a wide variety of other user interface options are available for use in connection with the present invention, including pressing a button on a gaming machine, touching a segment of a touch-screen, entering text, entering voice commands, or other known user entry methodology.

The display device 604 of FIG. 6 includes a display screen 610. The display device may take on a variety of forms depending on what type of presentation is to be provided. For example, a slot game area 620 is provided where the slot gaming activity in accordance with the invention is displayed. The video display screen may be implemented in a variety of manners, including electronically represented with outputs shown on conventional electronic displays, such as a liquid crystal displays (LCD), dot matrix, plasma, CRT, LED, electro-luminescent display, or generally any type of video display known in the art.

Various types of grids, and ways to display them, are contemplated in the scope of the invention, including vertical, horizontal, and/or diagonal lines creating spaces of rectangles and/or squares. A display grid could also be comprised of triangles, hexagons, ovals, circles and other shapes.

A grid can be presented in various ways. For example, a display grid could be comprised of several reel strips with various markings on the periphery of the reel strips. Several reel strips with a common axis placed together can form a grid, with each reel strip representing a vertical column and adjacent markings on the aligned reels representing a horizontal row. A display grid could also be printed or formed on a surface, such as a piece of paper or board. A grid could also be represented by projected light. An array could be presented, modified and used in any way that a grid could be presented.

A display grid can also be presented by use of video means, such as with a video slot machine. In a video slot machine, the reel strips are not represented by physical material, but rather include electronically stored symbol patterns, i.e., a virtual reel strip. By using virtual reel strips for each of the display series, segments or subsegments, there is no physical correlation between display series, segments or subsegments as there are with mechanical reel strips. For example, in the context of mechanical reel strips, three symbols presented in a column across three pay lines are physically restricted to that particular order, since the reel strip is presented across three rows. In an exemplary embodiment of the invention, there is no such relationship and each subpart of the grid can display a marking independent of any other subpart. Furthermore, there are other advantages by using video representation, including faster game play, greater flexibility in game types and variations, and representation of things that would otherwise be physically complicated or impossible.

Associated with the display device 604 is an optional winning guide area 612, where information associated with the potential winning series lengths may be presented. This area may also provide an indication of the requisite symbols, symbol lengths, symbol combinations, symbol locations, etc. that result in winning payouts to the participant. This information may be part of the display screen 610, or alternatively may be separate from the display screen 610 and provided directly on a portion of the display device 604 structure itself. For example, a backlit colored panel may be used as the winning guide area 612. Further, this information may be provided on an entirely separate display screen (not shown).

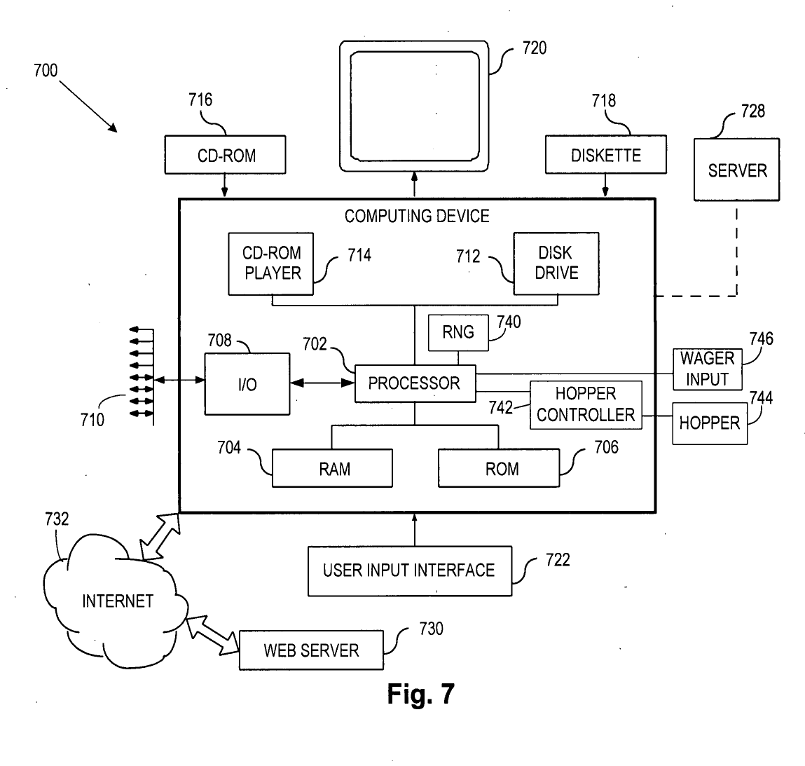

The gaming machines described in connection with the present invention may be independent casino gaming machines, such as slot machines or other special purpose gaming kiosks, video games, or may be computing systems operating under the direction of local gaming software and/or remotely-provided software such as provided by an application service provider (ASP). The casino gaming machines utilize computing systems to control and manage the gaming activity. An example of a representative computing system capable of carrying out operations in accordance with the invention is illustrated in FIG. 7.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 700 of FIG. 7 is an example computing structure that can be used in connection with such electronic gaming machines, computers, or other computer-implemented devices to carry out operations of the present invention.

The example computing arrangement 700 suitable for performing the gaming activity utilizing expanding-arrays and series of corresponding adjacent elements in accordance with the present invention typically includes a central processor (CPU) 702 coupled to random access memory (RAM) 704 and some variation of read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals, communication signals, and the like.

Chance-based gaming systems such as slot machines, in which the present invention is applicable, are governed by random numbers and processors. Electronic reels are used to display the result of the digital reels which are actually stored in computer memory and “spun” by a random number generator (RNG). RNGs are well-known in the art, and may be implemented using hardware, software operable in connection with the processor 702, or some combination of hardware and software. In accordance with generally known technology in the field of slot machines, the processor 702 associated with the slot machine, under appropriate program instruction, can simulate the vertical rotation of multiple reels. Generally, the RNG continuously cycles through numbers, even when the machine is not being played. The slot machine selects, for example, three random numbers. The numbers chosen at the moment the play is initiated are typically the numbers used to determine the final outcome, i.e., the outcome is settled the moment the reels are spun. The resulting random numbers are generally divided by a fixed number. This fixed number is often thirty-two, but for slot machines with large progressive jackpots it may be even greater. After dividing, the remainders will be retained. For example, if the divisor was one-hundred twenty-eight, the machine would have three remainders ranging from zero to one-hundred twenty-seven. The remainders may be considered as stops on virtual reels. If the divisor was one-hundred twenty-eight, then the virtual reels would each have one-hundred twenty-eight stops with each stop being equally likely. Each stop on the virtual reel may be mapped to a stop on an actual reel or displayed reel image. These reel images may then be displayed on the display 720. The present invention is operable using any known RNG, and may be integrally programmed as part of the processor 702 operation, or alternatively may be a separate RNG controller 740. RNGs are well known in the art, and any type of RNG may be implemented for the standard mode of play and/or the bonus mode of play in accordance with the invention. Such methods and devices can be used to select elements and/or markings, among other things.

The computing arrangement 700 may also include one or more data storage devices, including hard and floppy disk drives 712, CD-ROM drives 714, and other hardware capable of reading and/or storing information such as DVD, etc. In one embodiment, software for carrying out the gaming operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to the computing arrangement 700 via data signals, such as being downloaded electronically via a network, such as the Internet. Further, as previously described, the software for carrying out the functions associated with the present invention may alternatively be stored in internal memory/storage of the computing device 700, such as in the ROM 706. The computing arrangement 700 is coupled to the display 720, which represents a display on which the gaming activities in accordance with the invention are presented. The display 720 merely represents the “presentation” of the video information in accordance with the invention, and may be any type of known display or presentation screen, such as LCD displays, plasma display, cathode ray tubes (CRT), etc. Where the computing device 700 represents a stand-alone or networked computer, the display 720 may represent a standard computer terminal or display capable of displaying multiple windows, frames, etc. Where the computing device is embedded within an electronic gaming machine, such as slot machine 600 of FIG. 6, the display 720 corresponds to the display screen 610 of FIG. 6. A user input interface 722 such as a mouse or keyboard may be provided where the computing device 700 is associated with a standard computer. An embodiment of a user input interface 722 is illustrated in connection with an electronic gaming machine 600 of FIG. 6 as the various “buttons” 608. Other user input interface devices include a keyboard, a mouse, a microphone, a touch pad, a touch screen, voice-recognition system, etc.

In various embodiments of the invention, various aspects of the game, as described herein, may be player controlled. For example, a player may place bets, select game types, select play area types, select grid types, select array types, select themes, select symbols, select elements, select colors, and/or select markings.

The computing arrangement 700 may be connected to other computing devices or gaming machines, such as via a network. The computing arrangement 700 may be connected to a network server 728 in an intranet or local network configuration. The computer may further be part of a larger network configuration as in a global area network (GAN) such as the Internet. In such a case, the computer accesses one or more web servers 730 via the Internet 732.

Other components directed to slot machine implementations include manners of gaming participant payment, and gaming machine payout. For example, a slot machine including the computing arrangement 700 may also include a hopper controller 742 to determine the amount of payout to be provided to the participant. The hopper controller may be integrally implemented with the processor 702, or alternatively as a separate hopper controller 742. A hopper 744 may also be provided in slot machine embodiments, where the hopper serves as the mechanism holding the coins/tokens of the machine. The wager input module 746 represents any mechanism for accepting coins, tokens, coupons, bills, credit cards, smart cards, membership cards, etc. for which a participant inputs a wager amount.

Using the foregoing specification, the invention may be implemented as a machine, process, or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

The present invention is applicable to various gaming activities that are played on a gaming board or gaming machine, including slot games such as reel slots and video slots, and other games utilizing corresponding grid elements to generate a game result. The present invention is described in terms of slot machines to provide an understanding of the invention. While the invention is particularly advantageous in the context of slot machines, and while a description in terms of slot machines facilitates an understanding of the invention, the invention is also applicable to other gaming activities of chance utilizing symbol strings as will be readily apparent to those of skill in the art from the description provided herein.

The circuitry represented in FIG. 7 can be used to perform the various methodologies and techniques discussed herein. For example, RAM 704 can be a computer readable medium encoded with a computer program, software, computer executable instructions, instructions capable of being executed by a computer, etc, to be executed by circuitry, such as processor 702, to cause the various other components, such as user input 722, display 720, hopper controller 742 and hopper 744, RNG 470, etc. to perform the various operations discussed herein.

One skilled in the art of computer science from the description provided herein will be able to combine the software created as described with appropriate general purpose or special purpose computer hardware to create a computer system and/or computer subcomponents embodying the invention, and to create a computer system and/or computer subcomponents for carrying out methods of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, the present invention is not limited to what is traditionally known as “slot machines.” Also, while the illustrated embodiments have been described in large part in connection with a “slot machine,” other gaming systems and concepts are also within the scope of the invention, such as video poker games, card games, lotteries, and other casino events implementing a video screen. For example, a video poker game may utilize the present invention to provide multiple cards at each standard card display segment. It is thus intended that the scope of the invention be limited not with this detailed description, but rather by the claims appended hereto.

The following is claimed:

1. A method of facilitating participation in a game, comprising:
marking elements of a grid in an initial round;
evaluating the marked elements of the grid to identify correspondingly marked elements;
initiating a second round if the identified correspondingly marked elements exceed a threshold number, additional marked elements being added to the grid in the second round; and
successively adding marked elements to the grid for each of one or more additional rounds, each additional round being initiated if each respective preceding round expanded the number of correspondingly marked elements.

2. The method of claim 1, wherein the second round is initiated if the identified correspondingly marked elements are arranged adjacently in a series of correspondingly marked adjacent elements and each of the one or more additional rounds is initiated if each respective preceding round expanded the series of correspondingly marked adjacent elements.

3. The method of claim 2, wherein the marked elements are added in each of the second round and the one or more additional rounds such that no element of the series of correspondingly marked adjacent elements of each respective preceding round is located on an edge of the grid when addition of marked elements is complete for each of the second round and the one or more additional rounds.

4. The method of claim 2, wherein the marked elements are added in each of the second round and the one or more additional rounds such that no marked element added in each respective preceding round is located on an edge of the grid when addition of marked elements is complete for each of the second round and the one or more additional rounds.

5. The method of 2, wherein the second round is initiated if the series of correspondingly marked adjacent elements are arranged in a left to right orientation and each of the one or more additional rounds is initiated if each respective preceding round expanded the series of correspondingly marked adjacent elements in the left to right orientation.

6. The method of claim 2, further comprising:
defining a plurality of pay lines of the grid before the grid is marked; and
enabling one or more of the pay lines, each enabled pay line corresponding to a unique wager, wherein only series of correspondingly marked adjacent elements arranged along one of the one or more enabled pay lines will trigger a payout.

7. The method of claim 1, further comprising issuing a payout based on the number of correspondingly marked elements in the grid.

8. The method of claim 1, further comprising issuing a payout based on how many rounds are completed.

9. The method of claim 2, wherein each of the second round and one or more additional rounds are initiated only if the series of correspondingly marked elements span two opposing edges of the grid in each respective preceding round.

10. A gaming apparatus with an expanding array comprising:
a display device;
a processor; and
a computer-readable medium having instructions stored thereon which are executable by the processor for facilitating the expanding array game by performing steps comprising:
marking elements of a grid displayed on the display device in an initial round;
evaluating the marked elements of the grid to identify correspondingly marked elements;
initiating a second round if the identified correspondingly marked elements exceed a threshold number, additional marked elements being added to the grid in the second round; and
successively adding marked elements to the grid for each of one or more additional rounds, each additional round being initiated if each respective preceding round expanded the number of correspondingly marked elements.

11. The method of claim 10, wherein the computer-readable medium has further instructions stored thereon which are executable by the processor for facilitating the expanding array game such that the second round is initiated if the identified correspondingly marked elements are arranged adjacently in a series of correspondingly marked adjacent elements and each of the one or more additional rounds is initiated only if each respective preceding round expanded the series of correspondingly marked adjacent elements.

12. The method of claim 11, wherein the computer-readable medium has further instructions stored thereon which are executable by the processor for facilitating the expanding array game such that the marked elements are added in each of the second round and the one or more additional rounds such that no element of the series of correspondingly marked adjacent elements of each respective preceding round is located on an edge of the grid when addition of marked elements is complete for each of the second round and the one or more additional rounds.

13. The method of claim 11, wherein the computer-readable medium has further instructions stored thereon which are executable by the processor for facilitating the expanding array game such that the marked elements are added in each of the second round and the one or more additional rounds such that no marked element added in each respective preceding round is located on an edge of the grid when addition of marked elements is complete for each of the second round and the one or more additional rounds.

14. The method of claim 10, wherein the computer-readable medium has further instructions stored thereon which are executable by the processor for facilitating the expanding array game by performing steps comprising determining a payout based at least in part on how many rounds are completed.

15. A method of facilitating participation in a game, comprising:
marking elements of a grid in an initial round; and
successively adding marked elements to the grid for each of one or more additional rounds, each additional round being initiated if each respective preceding round expanded a series of corresponding adjacent elements that was originally formed in the first round such that at least one of the marked elements of the series is located on an edge of the grid at the end of each round that triggers another round of the one or more additional rounds.

16. The method of claim 15, further comprising issuing a payout, the amount of the payout related to the total number of elements comprising the series of corresponding adjacent marked elements.

17. The method of claim 15, wherein the marked elements added in each of the one or more additional rounds are added such that no marked element of the series of corresponding adjacent elements of each respective preceding round is located on the edge of the grid when addition of marked elements for each respective round is complete.

18. The method of claim 15, wherein the marked elements added in each of the one or more additional rounds are added such that all marked elements added in each respective preceding round is no longer located on the edge of the grid when addition of marked elements for each respective round is complete.

19. A method of facilitating participation in a game, comprising:
marking elements of a grid in an initial round;
successively adding marked elements to the grid for each of one or more additional rounds, each round of the one or more additional rounds being initiated if a previous one of the one or more additional rounds increased a number of corresponding elements; and
issuing a payout, the amount of the payout related to the total number of corresponding elements.

20. The method of claim 19, wherein the marked elements correspond if the markings of the elements correspond.

21. The method of claim 19, wherein marked elements are only added to the periphery of the grid.
